(19) United States
(12) Patent Application Publication
(10) Pub. No.: US 2009/0098396 A1
(43) Pub. Date: Apr. 16, 2009

(54) POWDER COATING COMPOSITIONS, METHODS FOR THEIR PREPARATION AND RELATED COATED SUBSTRATES

(75) Inventor: Anthony M. Chasser, Allison Park, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/870,031

(22) Filed: Oct. 10, 2007

(51) Int. Cl. B32B 27/06; B05D 1/04; C08K 3/08

(52) U.S. Cl. 428/457; 427/485; 522/81; 524/440; 524/599

(57) ABSTRACT

Powder coating compositions are disclosed that include non-rounded resin particles having electromagnetically conductive particles adhered thereto. Also disclosed are methods for making such powder coating compositions and substrates at least partially coated with a coating deposited from such powder coating compositions.

### FIELD OF THE INVENTION

The present invention relates to powder coating compositions. More particularly, the present invention relates to powder coating compositions comprising resin particles having electromagnetically conductive particles adhered thereto. The present invention also relates to methods for making such powder coating compositions and substrates at least partially coated with a coating deposited from such powder coating compositions.

### BACKGROUND OF THE INVENTION

It is often desirable to incorporate metallic flakes into powder coating compositions to provide a coating with a highly reflective, metallic appearance or to provide a sparkle finish. Incorporation of such particles, however, into powder coating compositions can be difficult. These particles are often either extruded with the other components of the powder coating or post-added to a coating after extrusion. Passing these particles through an extruder, however, can result in a loss of appearance or other characteristics and can alter the size and/or shape of the particles. For example, if metallic flake is extruded with the other components of a powder coating composition and subsequently ground, the flake will become distorted or partially destroyed which can result in the loss of at least some of its luster. Post-addition of metallic particles can also cause problems, particularly when applying the powder coating by electrostatic spray; these particles can pick up a charge differently than the other coating components, which can cause a “picture framing” effect upon electrostatic deposition, thus potentially diminishing the re-claim advantages of powder coatings.

It is known, so as to address the electrostatic spray problems described above, to bond metallic flakes to resin particles in a powder coating composition by placing the flakes and the resin particles in a high intensity-high shear mixer, such as a Henschel Mixer®, Welex® mixer, Bepex® mixer, or Mixaco mixer, and spinning the mixture at a high speed until the resin particles become sufficiently soft to bond to or at least associate with the electromagnetically conductive particles. Unfortunately, this high-shear mixing process can not only reduce the size of the metallic flake but can displace the protective coating that is often included thereon, potentially leading to oxidation, orientation, and/or reproducibility problems. Moreover, the process is expensive and requires special equipment to, for example, account for explosion risks.

As a result, it would be desirable to provide powder coating compositions that include electromagnetically conductive particles that are adhered to resin particles, wherein the electromagnetically conductive particles are not degraded. It would also be desirable to provide methods for making such powder coating compositions.

### SUMMARY OF THE INVENTION

In certain respects, the present invention is directed to powder coating compositions that comprise non-rounded resin particles having electromagnetically conductive particles adhered thereto, wherein the electromagnetically conductive particles are not substantially degraded.

In some respects, the present invention is directed to methods for making powder coating compositions. These methods comprise: (a) charging coating composition components to a container that is constructed of a material that is not electromagnetically conductive; and (b) exposing the coating composition components to electromagnetic radiation to cause melting of the resin particles. In these methods of the present invention, the coating composition components comprise: (i) resin particles, and (ii) electromagnetically conductive particles.

The present invention also relates to substrates at least partially coated with such powder coating compositions.

### BRIEF DESCRIPTION OF THE DRAWINGS

FIGS. 1-5 are optical micrograph images (20× magnification) of powder coatings according to Examples described herein.

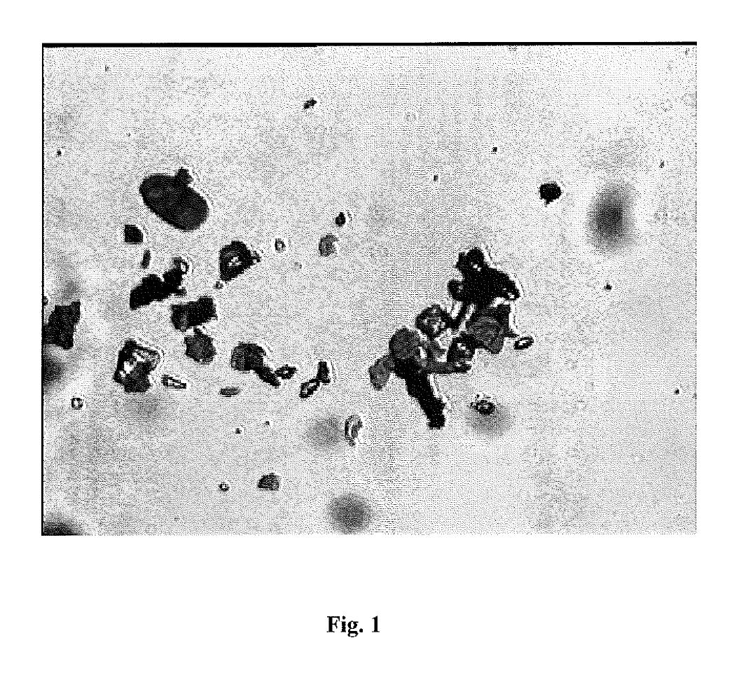

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

In certain embodiments, the present invention is directed to powder coating compositions. As used herein, the term “powder coating composition” refers to coating compositions wherein the coating components are embodied in a solid particulate form, as opposed to a liquid coating composition.

As indicated, in certain embodiments, the powder coating compositions of the present invention comprise “non-rounded resin particles.” As will be appreciated, powder coating compositions are often formed by the dry mixing of resin granules with other coating components, such as curing agents and other additives. This mixture is passed through an extruder, such as, for example, a twin screw extruder operated at a temperature of 90° C. to 130° C., wherein the coating components are melt-blended. The extrudate is then cooled to solidify the composition. Subsequently, the solidified extrudate is granulated and finely ground to produce particles of irregular shape and size. In many cases, the resulting irregularly shaped particles have an average particle size in the range of 0.1 to 500 μm, such as 10 to 300 μm, or, in some cases, 0.5 to 100 μm. As used herein, the term “non-rounded resin particles” refers to particles that comprise a resin and are of a discontinuous, irregular shape and size as opposed to particles whose surface is significantly or predominantly smooth and/or rounded as a result of, for example, (i) polishing, as described, for example, in U.S. Pat. No. 4,197,351 and/or (ii) heating the particles above the softening point of the resin such that the surface portions of the particles coalesce to provide, upon cooling, smooth, rounded or spherical shaped particles, such as is described in U.S. Pat. No. 5,472,649 and U.S Patent Application Publication 2006/0120912. The Examples described herein are illustrative of the non-rounded particles present in the powder coating compositions of the present invention. It should be understood, however, that the powder coating compositions of certain embodiments of the present invention may also include some rounded resin particles.

The resin particles present in the powder coating compositions of the present invention may comprise any resin that is capable of forming a film. In certain embodiments, the resin particles comprise a resin that contains a polymer having at least one type of reactive functional group that will react with the functional groups of a curing agent (described below). Suitable polymers include, for example, acrylics, polyesters, polyethers and/or polyurethanes and suitable functional groups include, for example, hydroxyl, carboxylic acid, carbamate, isocyanate, epoxy, amide and carboxylate functional groups. The appropriate selection of polymer(s) and, if used, curing agent(s) is within the skill of one practicing in the art.

The use in powder coatings of acrylic, polyester, polyether and polyurethane polymers having hydroxyl functionality is known. Monomers for the synthesis of such polymers are often chosen so that the resulting polymers have a glass transition temperature (“Tg”) greater than 30° C., such as greater than 50° C. Examples of such polymers are described in U.S. Pat. No. 5,646,228 at col. 5, line 1 to col. 8, line 7, the cited portion of which being incorporated by reference herein. Acrylic polymers and polyester polymers having carboxylic acid functionality are also suitable for powder coatings. Monomers for the synthesis for acrylic polymers having carboxylic acid functionality are typically chosen such that the resulting acrylic polymer has a Tg greater than 30° C., such as greater than 40° C., and for the synthesis of the polyester polymers having carboxylic acid functionality such that the resulting polyester polymer has a Tg greater than 30° C., such as greater than 50° C. Examples of carboxylic acid group-containing acrylic polymers are described in U.S. Pat. No. 5,214,101 at col. 1, line 59 to col. 3, line 23, the cited portion of which being incorporated by reference herein. Examples of carboxylic acid group-containing polyester polymers are described in U.S. Pat. No. 4,801,680 at col. 5, lines 38-65, the cited portion of which being incorporated by reference herein.

Carboxylic acid group-containing acrylic polymers can further contain a second carboxylic acid group-containing material selected from the class of C₄ to C₂₀ aliphatic dicarboxylic acids, polymeric polyanhydrides, low molecular weight polyesters having an acid equivalent from about 150 to about 750, and mixtures thereof. This material is crystalline and may be a low molecular weight crystalline or glassy carboxylic acid group-containing polyester.

Also useful in the present powder coating compositions are acrylic, polyester and polyurethane polymers containing carbamate functional groups. Examples are described in WO publication no. 94/10213, incorporated by reference herein. Monomers for the synthesis of such polymers are typically chosen so that the resulting polymer has a high Tg, that is, a Tg greater than 30° C. or, in some cases, greater than 40° C. The Tg of the various polymers described above can be determined by differential scanning calorimetry (DSC).

In certain embodiments of the powder coating compositions of the present invention, at least some of the previously described resin particles have electromagnetically conductive particles adhered thereto. The term “adhered” when used herein with reference to the relationship between a resin particle and an electromagnetically conductive particle, means that the electromagnetically conductive particle is attached, i.e., bonded, to the resin particle such that upon formation of the powder coating composition and its subsequent application to a substrate, such as by electrostatic spray, the electromagnetically conductive particle does not detach from the resin particle.

In certain embodiments of the present invention, the electromagnetically conductive particles are adhered to the resin particles without the use of an adhesive binder. For example, in certain embodiments, the electromagnetically conductive particles are adhered directly to the resin particles without the use of any other component that is intended to promote adhesion of the electromagnetically conductive particles to the non-rounded resin particles. As a result, in certain embodiments, the powder coating compositions of the present invention comprise resin particles having electromagnetically conductive particles adhered substantially directly thereto.

Any electromagnetically conductive particles are suitable for use in the present invention. As used herein, the term “electromagnetically conductive particles” refers to particles that are constructed of a material that conducts electric current and/or magnetic flux, such as metallic particles, including, but not limited to, particles constructed of aluminum, gold, silver, nickel, zinc, platinum, bronze, copper, brass, titanium, tungsten, stainless steel, including oxides and alloys thereof, to name a few. In some cases, such particles have a surface active agent deposited thereon, such as a saturated or unsaturated fatty acid, including, without limitation, oleic acid; stearic acid; and/or a derivative thereof; aliphatic amine; aliphatic amide; aliphatic alcohol; ester compound; and the like. These agents are effective in suppressing unnecessary oxidization of the surface of the metallic flake, such as aluminum flake.

In certain embodiments, the electromagnetically conductive particles present in the powder coating compositions of the present invention comprise particles that could and would be bent, deformed, oxidized and/or damaged when processed (i) in an extruder or similar apparatus, or (ii) in a high intensity-high shear mixer, such as those listed earlier, and spun at a high speed. In certain embodiments, the particles are lamellar pigments or fillers, and can include those having a high aspect ratio. The platelets that comprise such high aspect ratio fillers and/or pigments typically have diameters of from 1 to 20 microns, such as 2 to 5 or 10 microns. The aspect ratio of the platelets can be at least 5:1, such as at least 10:1 or 20:1, but can be as high as 200:1 to 10,000:1. It will be appreciated that many of the electromagnetically conductive particles present in the powder coating compositions of the present invention will have a special effect. “Special effect” can include particles that have a metallic appearance and/or particles wherein the perceived color or appearance can change based upon viewing angle, lighting conditions, temperature, etc.

The electromagnetically conductive particles used in the present invention can be in any form. For example, they can be in the form of a commercially available paste, dry powder, or suspended in liquid.

The size of the electromagnetically conductive particles can vary depending on the needs of the user. In certain embodiments, the average particle size is 1 to 100 microns, such as 3 to 60 microns, or, in some cases, 45 microns or less. Other embodiments contemplate larger particle sizes.

In order to add a variety of colors to the electromagnetically conductive particles, a variety of coloring agents or coloring pigments can be adhered to the surface of such particles. Examples of such coloring agents or coloring pigments include quinacridon, diketopyrrolopyrrole, isoindolinone, indanthrone, perylene, perynone, anthraquinone, dioxazine, benzoimidazolone, triphenylmethane quinophthalone, anthrapyrimidine, chrome yellow, pearl mica, transparent pearl mica, colored mica, interference mica, phthalocyanine, phthalocyanine halide, azo pigment (azomethine metal complex, condensed azo etc.), titanium oxide, carbon black, iron oxide, copper phthalocyanine, condensed polycyclic pigment, and the like.

Though a method of adhering the coloring pigment to the electromagnetically conductive particles is not limited, a method of adhering the coloring pigment to the electromagnetically conductive particles by coating the coloring pigment with a dispersant, followed by stirring and mixing the coloring pigment with the electromagnetically conductive particles before they are adhered to the non-rounded resin particles is often used.

Examples of the dispersant to be used in such a process include, without limitation, aromatic carboxylic acid such as benzoic acid, vinyl benzoate, salicylic acid, anthranilic acid, m-aminobenzoic acid, p-aminobenzoic acid, 3-amino-4-methylbenzoic acid, 3,4-diaminobenzoic acid, p-aminosalicylic acid, 1-naphthoic acid, 2-naphthoic acid, naphthenic acid, 3-amino-2-naphthoic acid, cinnamic acid, and aminocinnamic acid; amino compound such as ethylenediamine, trimethylenediamine, tetramethylenediamine, pentamethylenediamine, hexamethylenediamine, 1,7-diaminoheptane, 1,8-diaminooctane, 1,10-diaminodecane, 1,12-diaminododecane, o-phenylenediamine, m-phenylenediamine, p-phenylenediamine, 1,8-diaminonaphthalene, 1,2-diaminocyclohexane, stearylpropylenediamine, N-β-(aminoethyl)-γ-aminopropyltrimethoxysilane, and N-β-(aminoethyl)-γ-amino-propylmethyldimethoxysilane; and aluminum or titanium chelate compound.

As previously indicated, in certain embodiments of the powder coating compositions of the present invention, the electromagnetically conductive particles are not substantially degraded. As used herein, when it is stated that the electromagnetically conductive particles are not “substantially degraded” it means that the properties of the particles have not been substantially affected as a result of the process by which the electromagnetically conductive particles have been adhered to the resin particles. For example, as indicated earlier, those skilled in the art will appreciate that certain methods of adhering electromagnetically conductive particles to resin particles in a powder coating composition, such as those described above that involve the use of physical stress, including those that employ a high intensity-high shear mixer, such as those listed earlier, can and will deform and/or fragment the electromagnetically conductive particle, thus degrading the properties of the particle.

To determine whether the electromagnetically conductive particles present in a powder coating composition are “substantially degraded”, for purposes of the present invention, one should compare the physical characteristics of the electromagnetically conductive particles, such as size, shape, and composition, before and after they are adhered to the resin particles. If the physical characteristics have not been altered to an extent that a property of the particle is altered, then the electromagnetically conductive particles are not substantially degraded. For example, in a bonding operation that uses high-shear conditions, the physical characteristics of the electromagnetically conductive particles are altered to such an extent that one or more properties of the particles are negatively affected. In a particular example, by way of illustration, in the case of aluminum particles a bonding process comprising the use of high-shear conditions will negatively effect the corrosion and/or chemical resistance performance of such particles due, it is believed, to the reduction in the size of the aluminum flake and/or the displacement of the protective coating, such as stearic acid, on the aluminum flake.

In addition to the previously described components, the powder coating compositions of the present invention may also include additional components. For example, as indicated earlier, a curing agent is often used. Suitable curing agents include, without limitation, blocked isocyanates, uretidiones, polyepoxides, polyacids, polyols, anhydrides, polyamines, aminoplasts and phenoplasts. As previously indicated, the appropriate curing agent can be selected by one skilled in the art depending on the polymer used. For example, blocked isocyanates are suitable curing agents for hydroxy and primary and/or secondary amino group containing materials. Examples of blocked isocyanates are those described in U.S. Pat. No. 4,988,793, at col. 3, lines 1-36, the cited portion of which being incorporated by reference herein. Polyepoxides suitable for use as curing agents for COOH functional group-containing materials are described in U.S. Pat. No. 4,681,811 at col. 5, lines 33-58, the cited portion of which being incorporated by reference herein. Polyacids as curing agents for epoxy functional group-containing materials are described in U.S. Pat. No. 4,681,811 at col. 6, line 45 to col. 9, line 54, the cited portion of which being incorporated by reference herein. Polyols, materials having an average of 2 or more hydroxyl groups per molecule, can be used as curing agents for NCO functional group-containing materials and anhydrides, and are well known in the art. Polyols for use in the present invention are typically selected such that the resultant material has a Tg greater than about 30° C., in some cases greater than 50° C. Anhydrides as curing agents for epoxy functional group-containing materials include, for example, trimellitic anhydride, benzophenone tetracarboxylic dianhydride, pyrrolmellitic dianhydride, tetrahydrophthalic anhydride, and the like as described in U.S. Pat. No. 5,472,649 at col. 4, lines 49-52, the cited portion of which being incorporated by reference herein. Aminoplasts as curing agents for hydroxy, COOH, and carbamate functional group-containing materials are well known in the art. Examples of such curing agents include aldehyde condensates of glycol urea, which give high melting crystalline products useful in powder coatings. While the aldehyde used is typically formaldehyde, other aldehydes such as acid aldehyde, crotonaldehyde, and benzaldehyde can be used.

The resin particles described above are often present in the powder coating compositions of the present invention in an amount greater than 50 weight percent, such as greater than 60 weight percent, and less than or equal to 95 weight percent, with weight percent being based on the total weight of the powder coating composition. For example, the weight percent of resin can be between 50 and 95 weight percent. When a curing agent is used, it is often present in an amount of 5 to 50 weight percent; this weight percent is also based on the total weight of the powder coating composition.

In certain embodiments, the electromagnetically conductive particles described above are present in the powder coating compositions of the present invention in an amount of at least 0.1 percent by weight, in some cases at least 1 percent by weight, or, in yet other cases, at least 3 percent by weight. In certain embodiments, the electromagnetically conductive particles described above are present in the powder coating compositions of the present invention in an amount of no more than 30 percent by weight, such as no more than 15 percent by weight, or, in some cases, no more than 12 percent by weight. The foregoing weight percents being based on the total weight of the powder coating composition.

The powder coating compositions of the present invention may optionally contain additives such as waxes for flow and wetting, flow control agents such as poly(2-ethylhexyl)acrylate, degassing additives such as benzoin and microwax C, adjuvant resin to modify and optimize coating properties, antioxidants, ultraviolet (UV) light absorbers and catalysts. Examples of useful antioxidants and UV light absorbers include those available commercially from Ciba Specialty Chemicals under the trademarks IRGANOX and TINUVIN. These optional additives, when used, are typically present in amounts up to 20 weight percent, based on the total weight of the coating composition.

In certain embodiments, the powder coating compositions of the present invention also comprise a colorant, which is distinct from any of the colored electromagnetically conductive particles described above. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of “resin-coated particles” that comprise a particle, such as a nanoparticle, and a resin coating on the nanoparticle. Example resin-coated nanoparticles and methods for making them are identified in U.S. patent application Ser. No. 11/337,062, filed Jan. 20, 2006, which are incorporated herein by reference.

Example special effect compositions that may be used in the coating compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The powder coating compositions described above can be made by a method comprising: (a) charging coating composition components that comprise resin particles, in some cases, non-rounded resin particles, and electromagnetically conductive particles to a container that is constructed of a material that is not electromagnetically conductive; and (b) exposing the coating composition components to electromagnetic radiation to cause melting, in some cases, localized melting, of the resin particles. As a result, certain embodiments of the present invention are directed to such methods.

As indicated, according to certain embodiments of the methods of the present invention, the coating composition components, which include, but are not necessarily limited to, the previously described non-rounded resin particles and the previously described electromagnetically conductive particles, are charged to a container that is constructed of a material that is not electromagnetically conductive, i.e., an insulator, which is a material or object which contains no free electrons to permit the flow of electricity. Examples include plastics, glass, ceramics, and rubbers. If desired, the non-rounded resin particles and the electromagnetically conductive particles can be mixed, such as by light stirring, to achieve a relatively uniform distribution of the electromagnetically conductive particles throughout the resin particles, so long as, in certain embodiments, such mixing does not degrade the electromagnetically conductive particles.

Thereafter, according to certain embodiments of the methods of the present invention, the coating composition components are exposed to electromagnetic radiation. Electromagnetic radiation is classified into types according to the frequency of the wave: these types include, in order of increasing frequency, radio waves, microwaves, terahertz waves, infrared radiation, visible light, ultraviolet radiation, X-rays, and gamma ray. In certain embodiments of the present invention, the electromagnetic radiation comprises microwave energy. Microwaves are electromagnetic waves with wavelengths approximately in the range of 30 cm (frequency=1 GHz) to 1 mm (300 GHz).

In certain embodiments, the coating composition components are exposed to microwave radiation having a power of 15 to 15,000 Watts, such as 100 to 1,000 Watts, or in some cases 100 to 200 Watts, for a period of no more than 10 minutes, such as no more than 5 minutes, in some cases no more than 1 minute, no more than 30 seconds, or, in some cases, no more than 10 seconds or no more than 5 seconds.

As previously indicated, in certain embodiments of the methods of the present invention, the exposure of the coating composition to electromagnetic radiation causes “localized” melting of the resin particles. As will be appreciated, upon exposure to electromagnetic radiation, the electromagnetically conductive particles present in the coating composition will conduct electromagnetic energy. This energy causes the portions of the non-rounded resin particles (which are resistive to electromagnetic energy) that are in contact with or very near the point of contact with the electromagnetically conductive particles to increase in temperature. Eventually, such portions of the resin particles will melt and, upon cooling, the electromagnetically conductive particle will be adhered to the resin particles.

It should be noted, however, that in certain methods of the present invention, only the portions of the resin particles in contact with or very near the point of contact with the electromagnetically conductive particles are melted. In other words, in these embodiments, the electromagnetic radiation is not continued to a point where most or all of the surface portions of the particle are melted, i.e., fluidized. As a result, the resin particles remain non-rounded after completion of the electromagnetic radiation exposure. Accordingly, these embodiments of the present invention differ significantly from methods of adhering electromagnetically conductive particles to resin particles that involve polishing the particles and/or melting most or all of the surface portions of the resin particles such that upon coalescence the resulting resin particles have a smooth, rounded or spherical shape. In addition, certain embodiments of the present methods avoid any significant fusing of the resin particles to one another, as is often the case with melt-bonding methods for adhering metallic flakes to resin particles. In certain embodiments of the methods of the present invention, however, the resin particles may be completely melted if desired.

In certain embodiments, the methods of the present invention provide significant benefits from a safety and/or environmental standpoint. The process does not utilize high-shear mixing conditions involving the electromagnetically conductive particles, thereby obviating the explosion risks associated therewith. The process need not use solvent, and so may be provided in one embodiment as a more environmentally friendly process as compared to a process that uses solvent. In certain embodiments, as indicated earlier, the methods of the present invention do not utilize adherents such as adhesives, waxes, etc that could otherwise adversely affect the final properties of the ultimate coating made from the powder coating composition.

The resulting powder coating compositions are most often applied to a substrate by spraying, and in the case of a metal substrate, by electrostatic spraying, or by the use of a fluidized bed. The powder coating composition can be applied in a single sweep or in several passes to provide a film having a thickness after cure of from 1 to 10 mils (25.4 to 254 microns), such as 2 to 4 mils (50.8 to 101.6 microns). Other standard methods for coating can be employed, such as brushing, dipping or flowing. As discussed above, the present powder coatings have enhanced performance during electrostatic spraying, as compared with other coatings prepared using electromagnetically conductive particles that are not adhered to resin particles, as in the present invention.

The coating compositions of the present invention are suitable for application to many types of substrates. Suitable substrates may include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable substrates include metallic substrates, such as, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics.

In some cases, polymeric substrates may be suitable and include, for example, polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

In some cases, textile substrates may be suitable and include, for example, fibers, yarns, threads, knits, wovens, nonwovens and garments composed of polyester, modified polyester, polyester blend fabrics, nylon, cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric.

Leather substrates may be suitable, such as grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine/, dicyanodiamide/and/or urea/formaldehyde resins.

In some cases, the powder coating compositions of the present invention may be suitable for application to compressible substrates, such as foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe midsoles. Different types of EVA foam can have different types of surface porosity. Molded EVA can comprise a dense surface or “skin”, whereas flat sheets or slabs can exhibit a porous surface.

Generally, after application of the powder coating composition, the coated substrate is baked at a temperature sufficient to cure the coating. Metallic substrates with powder coatings are typically cured at a temperature ranging from 230° F. to 650° F. for 30 seconds to 30 minutes.

As a result, the present invention is also directed to substrates, such as metal substrates, at least partially coated with a powder coating composition of the present invention as well as substrates, such as metal substrates, at least partially coated with a multi-component composite coating wherein at least one layer of the multi-layer composite coating is deposited from a coating composition of the present invention.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1

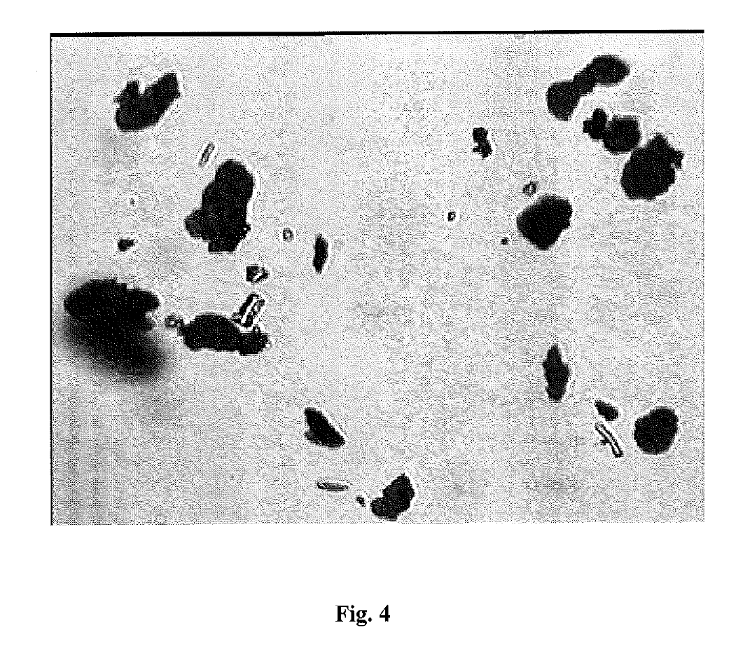

Approximately 0.5 grams of a previously mixed combination of epoxy resin particles and aluminum flake particles was placed in a suitable container that was constructed of a non-electromagnetically conductive material. The combination was hand stirred in the vessel. FIG. 4 is an optical micrograph image (20× magnification) of the combination. In this example, the aluminum flake particles are not adhered, i.e., bonded, to the epoxy resin powder.

### Example 2

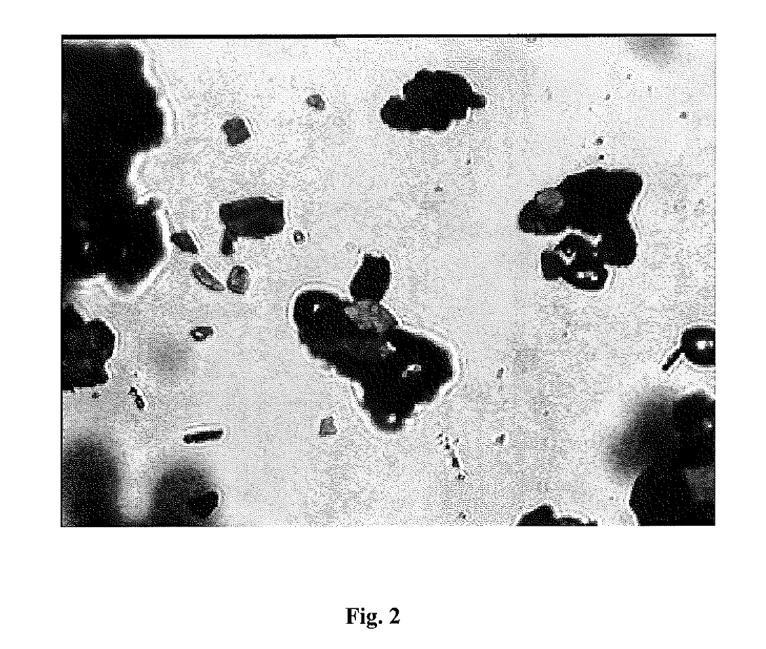

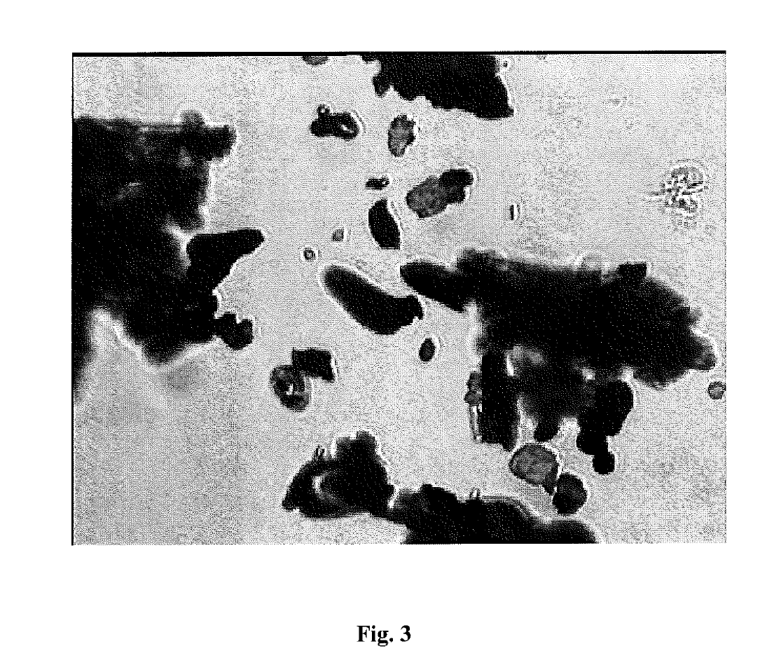

The combination described in Example 1 was irradiated with 50% of 150 W microwave power for 15 seconds. FIGS. 2 and 3 are optical micrograph images (20× magnification) of the combination after such irradiation. In this example, the aluminum flake particles are adhered, i.e., bonded, to the epoxy resin powder.

### Example 3

Approximately 100 grams of a previously mixed combination of epoxy resin particles and aluminum flake particles was placed in a 1 centimeter diameter cylindrical vessel. The combination was not stirred in the vessel. FIG. 4 is an optical micrograph image (20× magnification) of the combination. In this example, the aluminum flake particles are not adhered, i.e., bonded, to the epoxy resin powder.

### Example 4

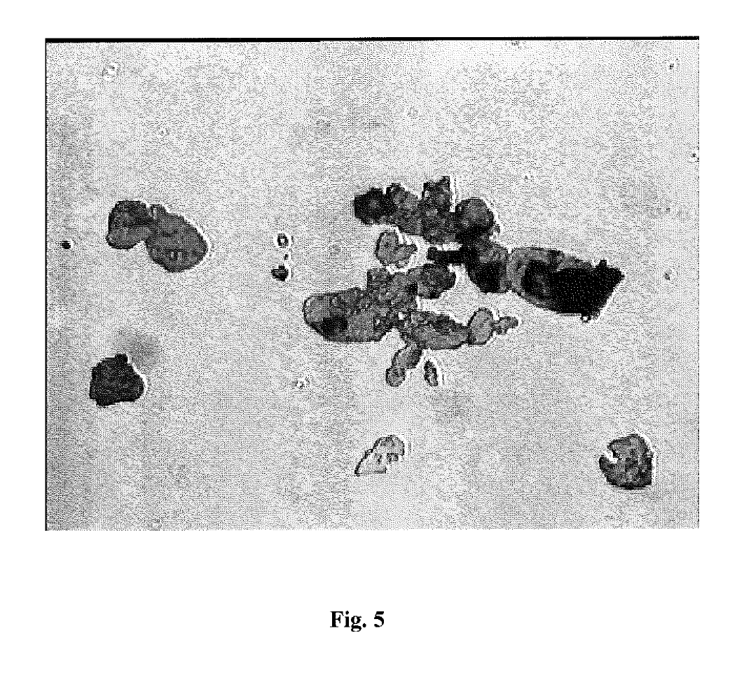

The combination described in Example 3 was irradiated with 600 W microwave power for various periods of time. The temperature of the combination was measured after irradiation. Results are set forth in Table 1. FIG. 5 is an optical micrograph images (20× magnification) of the combination after such irradiation for 2-3 minutes. In this example, the aluminum flake particles are adhered, i.e., bonded, to the epoxy resin powder.

TABLE 1

| Exam- | | Temper- | |
|---|---|---|---|
| ple | Conditions | ature | Comments |
| 4a | Irradiation for | — | The process was immediately |
| | 3½ minutes | | stopped when the material started |
| | after hand | | to get sticky. Small soft |
| | stirring | | crumbles were obtained |
| 4b | Irradiation for | 54° C. | The process was stopped before the |
| | 3 minutes after | | material was sticky. |
| | hand stirring | | |
| 4c | Irradiation for | 50° C. | The process was stopped before the |
| | 3½ minutes | | material got sticky. |
| | after hand | | |
| | stirring | | |

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A powder coating composition comprising non-rounded resin particles having electromagnetically conductive particles adhered thereto, wherein the electromagnetically conductive particles are not substantially degraded.

2. The powder coating composition of claim 1, wherein the resin particles comprise an acrylic and/or polyester polymer.

3. The powder coating composition of claim 1, wherein the resin particles comprise a polymer having a glass transition temperature greater than 30° C.

4. The powder coating composition of claim 1, wherein the electromagnetically conductive particles are adhered to the non-rounded resin particles without the use of an adhesive binder.

5. The powder coating composition of claim 4, wherein the electromagnetically conductive particles are adhered directly to the non-rounded resin particles.

6. The powder coating composition of claim 1, wherein the electromagnetically conductive particles comprise particles of aluminum, gold, silver, nickel, zinc, platinum, bronze, copper, brass, titanium, tungsten, stainless steel and/or an alloy thereof.

7. The powder coating composition of claim 1, wherein the electromagnetically conductive particles are platelets having an aspect ratio of at least 5:1.

8. A substrate at least partially coated with a coating deposited from the powder coating composition of claim 1.

9. A method for making powder coating composition comprising:
(a) charging coating composition components to a container constructed of material that is not electromagnetically conductive, the coating composition components comprising:
(i) resin particles and
(ii) electromagnetically conductive particles; and
(b) exposing the coating composition components to electromagnetic radiation to cause melting of the resin particles.

10. The method of claim 9, wherein the resin particles are non-rounded resin particles.

11. The method of claim 9, wherein the electromagnetic radiation causes localized melting of the resin particles.

12. The method of claim 9, wherein the electromagnetic radiation comprises microwave energy.

13. The method of claim 9, wherein the resin particles remain non-rounded after completion of the electromagnetic radiation exposure.

14. The method of claim 9, wherein the electromagnetically conductive particles are platelets having an aspect ratio of at least 5:1.

15. The method of claim 9, wherein the electromagnetically conductive particles are not degraded after completion of the electromagnetic radiation exposure.

16. A method of coating at least a portion of a substrate comprising:
(a) making a powder coating composition according to the method of claim 9; and
(b) depositing the powder coating composition onto at least a portion of the substrate.

17. The method of claim 16, wherein the powder coating composition is deposited onto the substrate by electrostatic spray.
